(19) United States
(12) Patent Application Publication
(10) Pub. No.: US 2013/0041720 A1
(43) Pub. Date: Feb. 14, 2013

(54) SYSTEM AND METHOD FOR REAL-TIME SATISFACTION SURVEY FEEDBACK

(71) Applicant: Collin Richard SPIRES, Canmore (CA)

(72) Inventor: Collin Richard SPIRES, Canmore (CA)

(21) Appl. No.: 13/572,187

(22) Filed: Aug. 10, 2012

Related U.S. Application Data
(60) Provisional application No. 61/523,141, filed on Aug. 12, 2011.

(51) Int. Cl. G06Q 30/02

(52) U.S. Cl. 705/7.32

(57) ABSTRACT

The present disclosure relates to a system and method for providing virtually real-time or near real-time satisfaction survey feedback received from a customer to allow for corrective action to be taken by an appropriate business agent almost immediately, or preferably within a few hours of the completion of a survey, before the customer has any significant opportunity to provide negative feedback via online media or other communication channels. In an embodiment, the present system and method provides an interactive electronic survey platform—for example a touch screen display or kiosk set up near the lobby of a hotel, or on a mobile platform such as a tablet at a restaurant table—offering an incentive for customers to complete a short interactive satisfaction survey.

### CROSS-REFERENCE TO RELATED APPLICATIONS

This application claims the benefit of U.S. Provisional Application No. 61/523,141 filed on Aug. 12, 2011, the entirety of which is incorporated herein by reference.

### FIELD OF THE INVENTION

The present disclosure relates generally to a system and method for providing real-time or near real-time feedback for satisfaction surveys.

### BACKGROUND

Presently, businesses in a number of service industries such as hotels, restaurants, transportation, retail, and financial services regularly conduct customer satisfaction surveys in order to receive continuing feedback from their customers on the level of satisfaction of their service experience. This feedback may be useful for improving the service such that customer satisfaction is increased. However, response levels to requests for customers to fill out satisfaction surveys are often poor, and if a survey is filled out and left in a comments or suggestions drop box, the time between receiving the survey results and responding to any concerns raised by a customer may be many hours, days or even weeks after the survey was completed. This substantial lag time in response may allow a dissatisfied customer ample opportunity to spread negative feedback about their experience by word of mouth, or worse, at highly visible online consumer review websites for trips, restaurants and other types of services which may cause significant damage to the reputation of a business.

What is needed is an improved system and method for addressing at least some of these limitations in the prior art.

### SUMMARY

The present disclosure relates to a system and method for providing real-time or near real-time satisfaction survey feedback received from a customer to allow for corrective action to be taken by an appropriate business agent almost immediately, or preferably within a few hours of the completion of a satisfaction survey, before the customer has any significant opportunity to provide negative feedback via online media or other communication channels.

In an embodiment, the present system and method provides an interactive electronic survey platform at a preferred survey location—for example a touch screen display or kiosk set up near the lobby of a hotel, or on a mobile platform such as a tablet at a restaurant table—offering an incentive for customers to complete a short interactive satisfaction survey. In an embodiment, the electronic survey platform is operatively connected to a back-end server executing a survey monitoring module, which receives the customer satisfaction survey results virtually in real-time or near real-time, and monitors the customer satisfaction survey results for any dissatisfaction levels below a minimum threshold. For example, if a customer satisfaction survey reveals a poor or very poor service experience, the survey results are immediately communicated to an appropriate human agent, such as an on-duty hotel manager in the case of a hotel, or a restaurant manager in the case of a restaurant. The communication may be via wired communication means (e.g. to a desk telephone), or by wireless communication means to a wireless handheld device, such as a smart phone or tablet.

In response to receiving a customer satisfaction survey with a dissatisfaction outlier, the appropriate human agent can take immediate corrective steps to deal with the cause of a customer's dissatisfaction, and may offer appropriate compensation such as rewards or credits, or a suitable discount for the service received based on the severity of the problem.

Advantageously, by providing a platform for virtual real-time feedback of customer satisfaction surveys, a service business can take steps to improve their level of customer satisfaction and minimize or stop any negative feedback by the customer which may otherwise follow.

In this respect, before explaining at least one embodiment of the system and method of the present disclosure in detail, it is to be understood that the present system and method is not limited in its application to the details of construction and to the arrangements of the components set forth in the following description or illustrated in the drawings. The present system and method is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 shows a schematic block diagram of a real time customer satisfaction system in accordance with an embodiment;

FIG. 2A-2C show illustrative user interface screens for receiving real-time customer satisfaction survey feedback in the context of a restaurant in accordance with an embodiment;

FIGS. 3A-3C show illustrative user interface screens for administering the real-time customer satisfaction survey system;

FIGS. 4A-4C show illustrative user interface screens for receiving real-time customer satisfaction survey feedback in the context of a hotel in accordance with another embodiment;

FIGS. 5A-5F show illustrative user interface screens for administering the real-time customer satisfaction survey system;

FIGS. 6A-6D show illustrative user interface screens for receiving real-time customer satisfaction survey feedback in various languages in accordance with another embodiment;

FIG. 7 shows a schematic flow chart of a method in accordance with an embodiment; and

FIG. 8 shows a schematic block diagram of a generic computer device that may provide a suitable operating environment for various embodiments.

### DETAILED DESCRIPTION

As noted above, the present disclosure relates to a system and method for providing real-time or near real-time satisfaction survey feedback received from a customer. In an embodiment, this virtually real-time communication of a customer's survey results is communicated via wired or wireless communication means to an appropriate business agent to allow for corrective action to be taken almost immediately, or preferably within a few hours of the completion of a survey before the customer has any significant opportunity to provide negative feedback via online media or other communication channels.

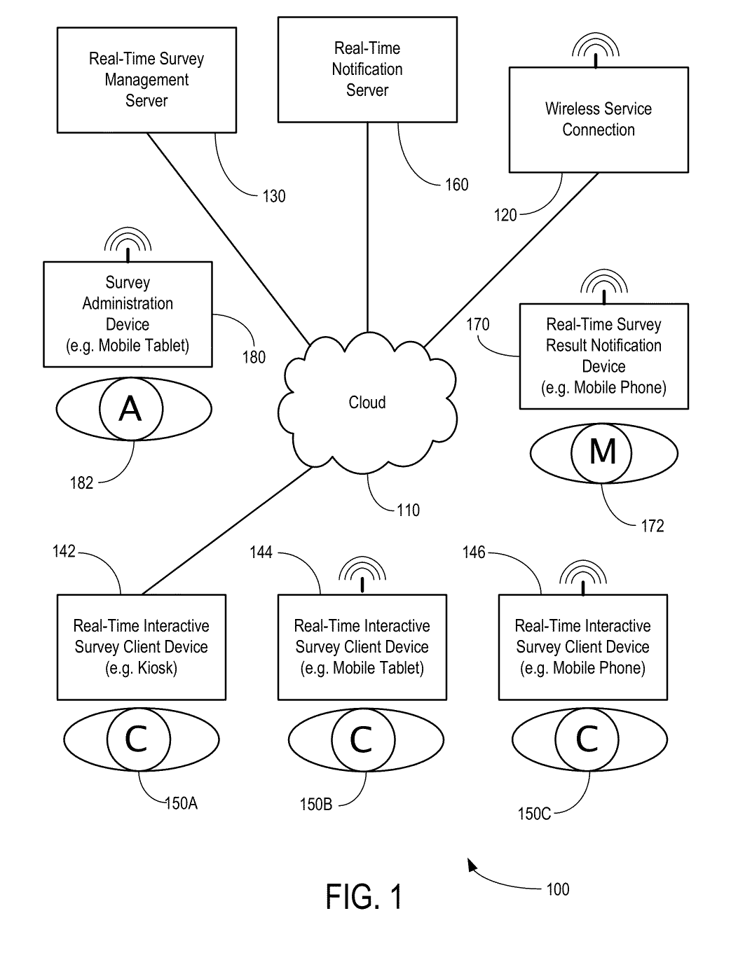

Referring to FIG. 1, shown is a schematic block diagram of a system 100 in accordance with an embodiment. System 100 has various components connected via a network or cloud 110, whether wired or wireless, via wireless service connection 120. In an embodiment, a real-time survey management server 130 provides administrative controls to manage the survey management system 100 as discussed in more detail below. Real-time survey management server 130 is operatively connected to a number of real-time interactive survey client devices including, for example, a kiosk 142 serving a guest 150A located near the entrance/exit to a location to a hotel, a mobile tablet 144 that may be handed to guest 150B sitting at a dining table in a restaurant, or on a mobile phone 146 that belongs to a patron 150C in a larger facility.

In an embodiment, real-time interactive survey client devices 142, 144, 146 may be operatively connected via wired or wireless connections through cloud 110 to real-time survey management server 130. As will be explained in further detail below, when a real-time interactive survey result is received from one or more of the client devices 142, 144, 146, the survey results are forwarded to survey management server 270 to be logged and processed.

In an embodiment, system 100 is configured to determine whether the survey results or any part thereof completed by a guest have exceeded or fallen below acceptable levels. In the event that survey results completed by a user indicate a less than satisfactory experience (at a hotel or a restaurant, for example), system 100 may issue an immediate notification of such a condition. As an illustrative example, system 100 may issue a real-time, or substantially real time notification via a sub module within real-time survey management server 130. Alternatively, a real-time notification server 160 may be used to direct the notification by system 100 to a real-time survey result notification device 170 to alert a human agent 172. For example, the human agent may be an on-duty hotel manager, or a manager at a restaurant.

In an embodiment, real-time survey management server 130 also provides access via a survey administration user interface device 180 to allow an administrator 182 to administer and manage the system 100. In this illustrative example, administrator 182 is also able to monitor real-time surveys provided by various guests or customers, change various settings such as the list of survey questions asked, and generate various reports. Preferably, real-time management server 130 is accessible by administrator 182 from virtually anywhere in the world with Internet access, such that the surveys may be centrally managed (e.g. from company headquarters) if desired.

The system 100 and its various components will be described in further detail below with reference to two illustrative use cases, including a first use case involving a survey conducted at a restaurant, and a second use case involving a survey conducted at a hotel.

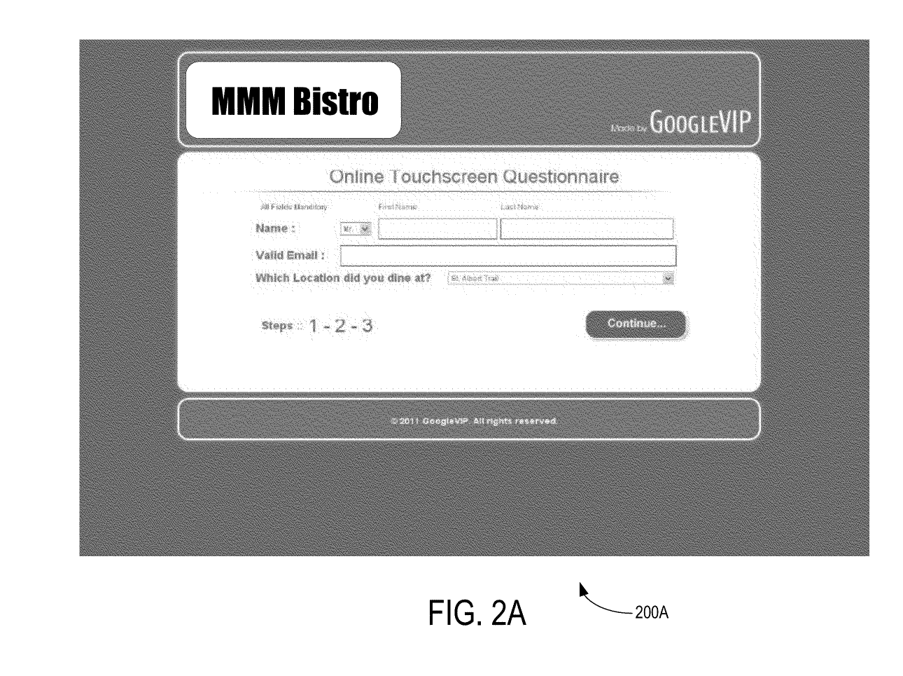

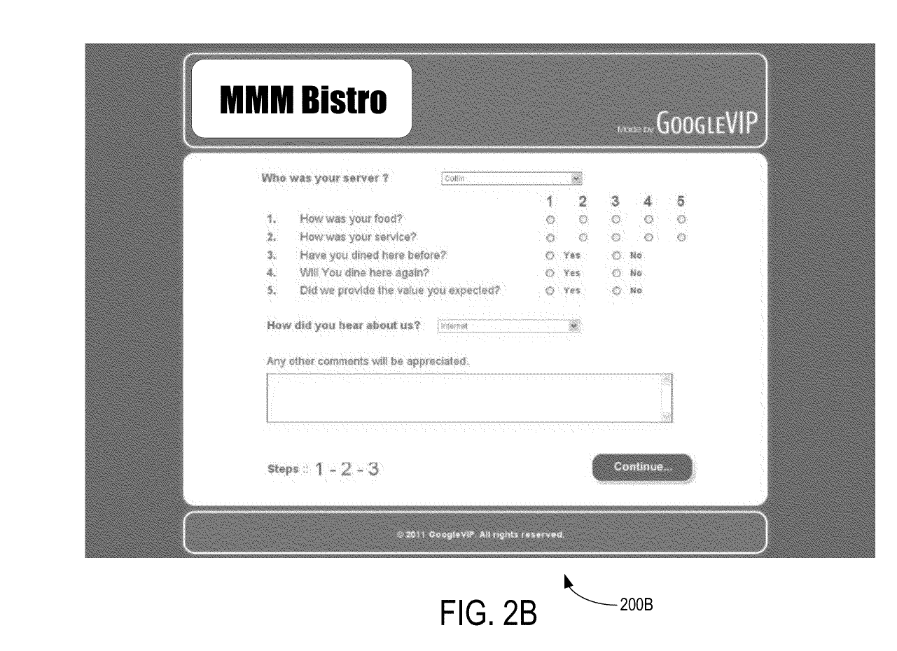

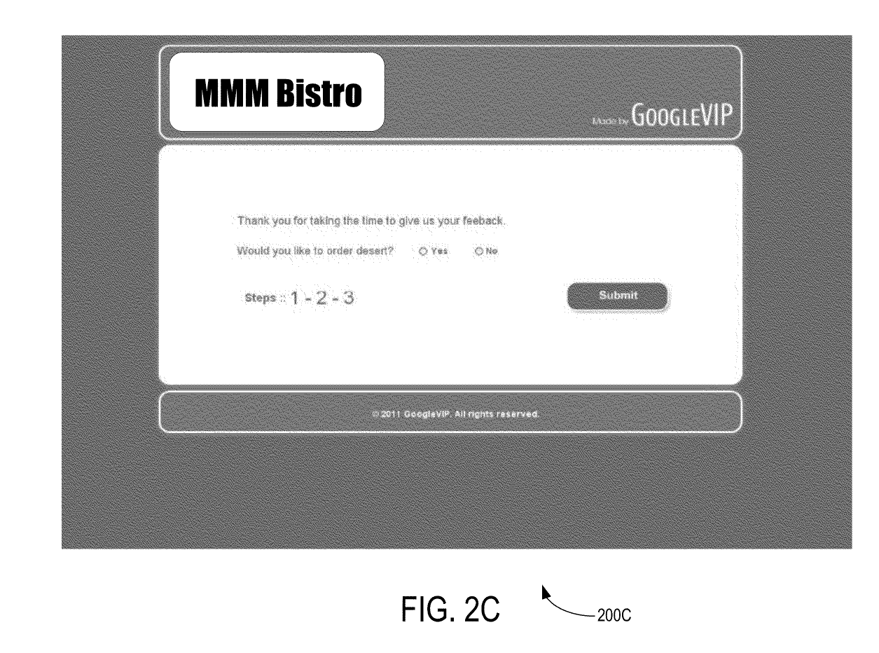

Now referring to FIG. 2A, shown is an illustrative user interface 200A for a welcome screen for providing a real-time survey on a just completed meal at a restaurant named MMM Bistro. In an illustrative embodiment, the survey may be conducted via a real-time interactive survey device, such as a mobile tablet 144 as previously described. As an example, upon completing a main course, a waiter may bring a mobile tablet 144 to a table and ask the guest(s) to fill out a short survey to provide feedback to the restaurant. In an embodiment, an incentive for completing the survey may be provided, such as a chance to win a free dinner, or to immediately receive a free dessert for completing the survey questionnaire. With this incentive, the restaurant guest may provide a name, valid email address, and if not already filled in, the location at which the guest(s) dined.

Upon providing the requested identification details, and selecting to continue, the guest is provided with another illustrative user interface 200B for a list of survey questions such as: “How was your food?”, “How was your service?”, “Have you dined here before?”, “ Will you dine here again?”, and “Did we provide the value you expected?”. The survey feedback screen may also provide other fields, such as “How did you hear about us”, and “Any other comments will be appreciated.”

In an embodiment, as each question on the survey screen is answered on a survey device 142, 144, 146, real-time survey management server 130 may be configured to monitor the various responses to determine if any of the responses are outside of a specified range. For example, depending on the administrator's configuration of the system and the survey questions, a notification to a survey result notification device may be triggered if a survey result falls below a minimum satisfaction level, such as for example 3 out of 5 for any key performance measure, or based on an average score of at least 3 out of 5 for all survey questions. As previously discussed, the notification may be provided via a sub module within real-time survey management server 130, or via a survey real-time notification server 170 which may be monitored by a suitable manager.

In an embodiment, the notifications triggered by real-time survey management server 130 are sent through real-time notification server 160 and wirelessly to real-time survey notification device 170. The lag time between completion of a survey question or questions, and notification to a manager 172 via notification server 170 many be in real-time, or near real-time, such that manager 172 can take immediate steps to remedy any issue which may have caused the guest to provide low or negative feedback for one or more questions.

Upon selecting to continue, another illustrative user interface 200C may thank the guest for completing the survey, and asking whether the guest would like to order a dessert, for example. While not shown, this survey device could be configured to display a dessert menu, for example, which may provide an option to select a free dessert for completing the survey, and to order other desserts and beverages such as coffee or tea for the table.

In this illustrative use case of real-time survey feedback in a restaurant, if a guest has provided a low score for one or more survey questions, the restaurant manager 172 may be immediately notified via her mobile phone 170, for example, such that she can come to the table to resolve the issue. In an embodiment, the notification of a low score may include the actual survey results, such that the manager 172 is aware that the guest has found the food to be good but the service was too slow. To resolve this issue, the manager 172 may authorize free desserts, for example, so that the guest leaves the restaurant in a better mood having had his concerns immediately dealt with.

In an embodiment, upon resolving a guest satisfaction issue, manager 172 may respond to the notification to indicate that the issue has been satisfactorily resolved, or that further follow up is required. Thus, providing real-time survey results may provide an opportunity to immediately resolve an issue and close it, or to take further steps as may be necessary to resolve the issue.

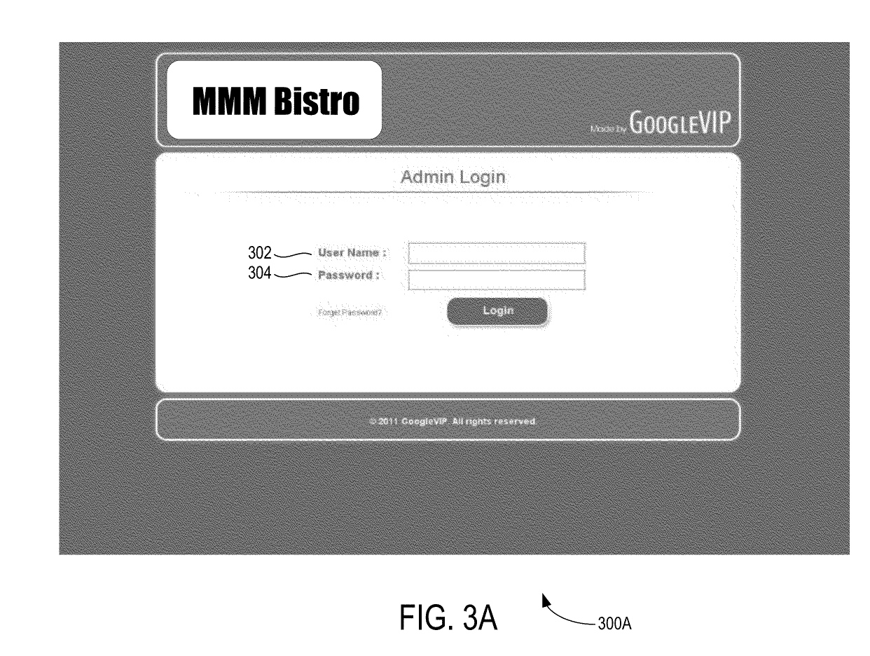

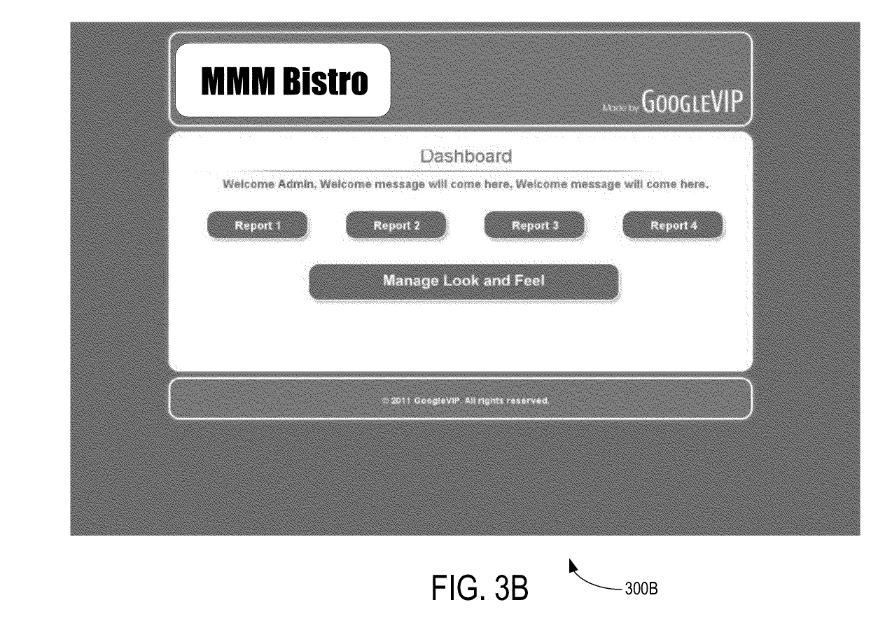

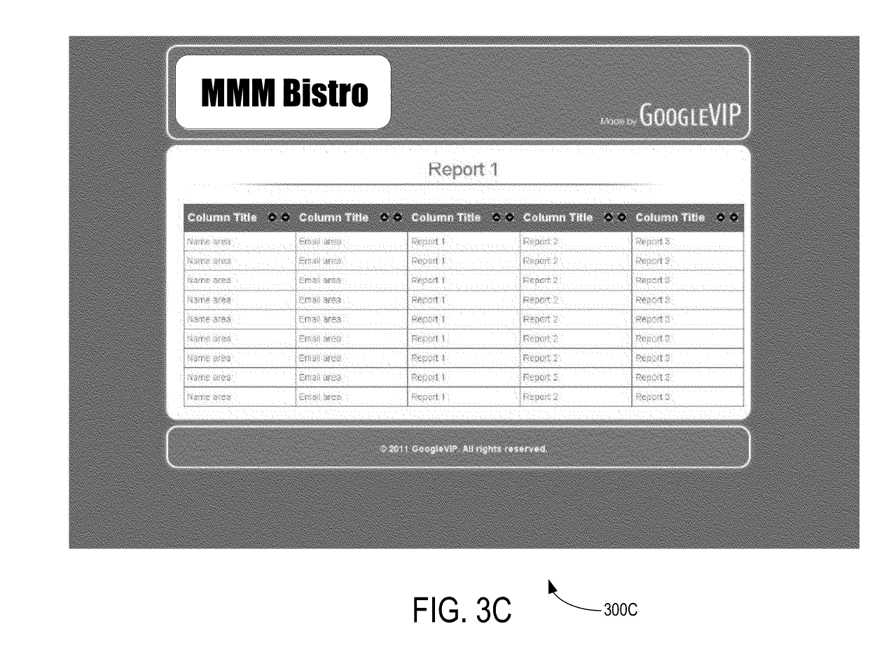

Now referring to FIG. 3A, shown is an illustrative user interface 300A for a login screen for an administrator 182 as may be provided on survey administration device 180, such as a wireless tablet for example. By entering a user name and password, the administrator is able to access a dashboard 300B shown in FIG. 3B, where the administrator can access a number of different types of reports, and also manage the look and feel of the survey screen 200B, by changing the survey questions, for example. FIG. 3C shows an illustrative example of one type of report, which may provide details on the feedback received from guests on a particular day, or guests served by a particular waiter, for example. The survey report may be as detailed as desired, including the particular dishes ordered by the guest(s) which resulted in positive or negative feedback.

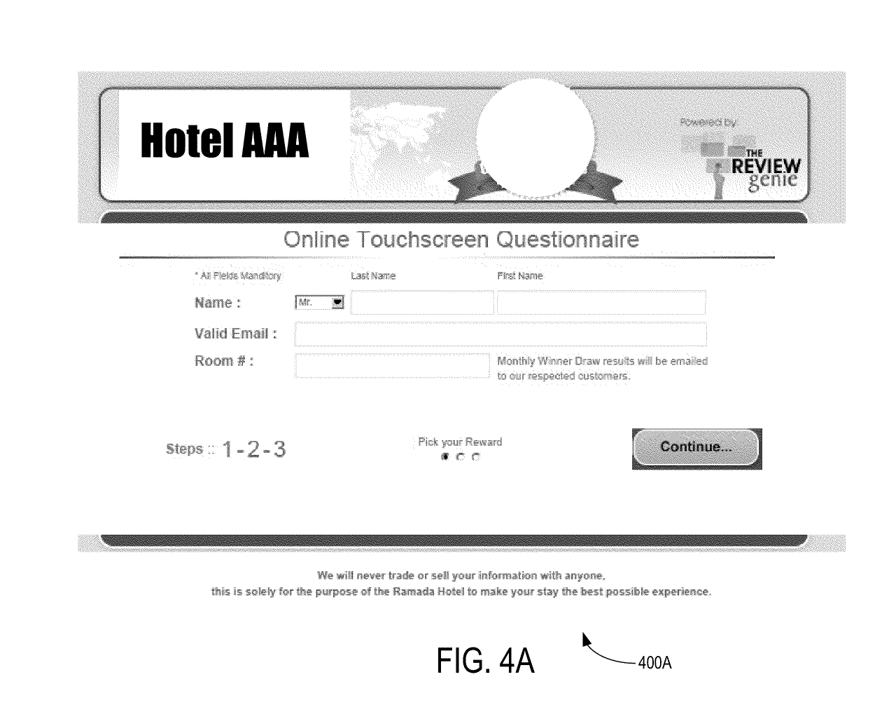

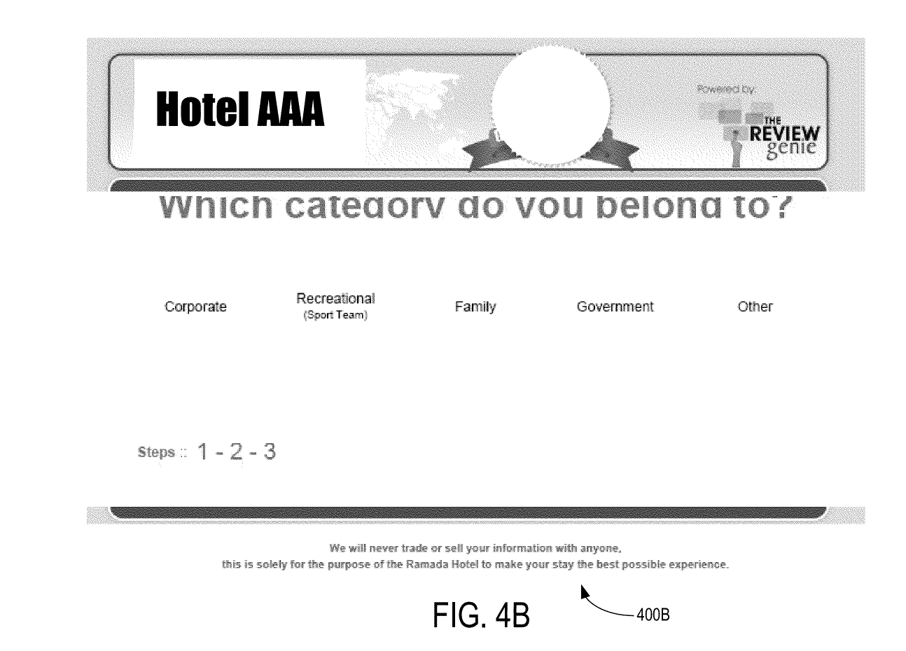

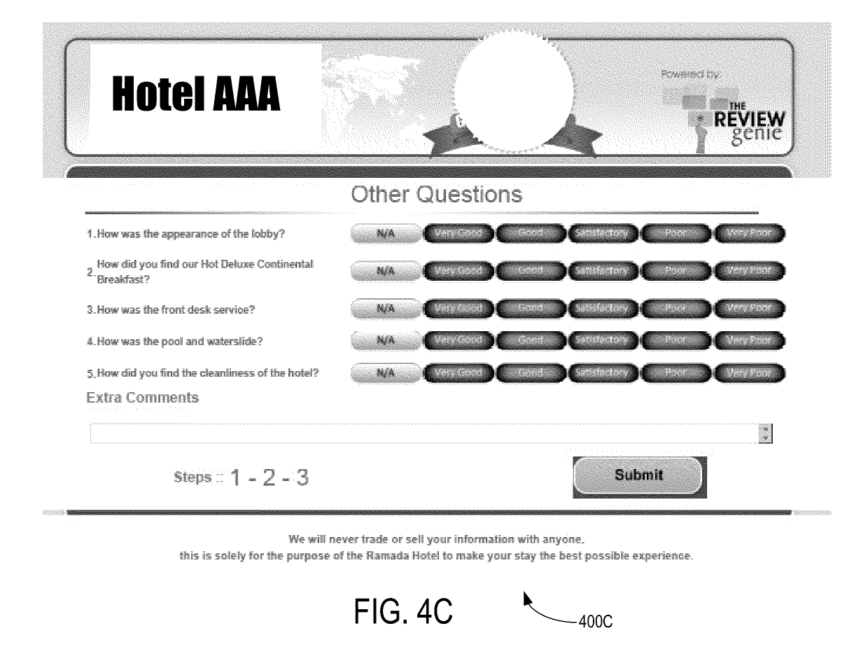

Now referring to FIGS. 4A-4C, as another illustrative use case, shown are user interface screens for receiving real-time customer satisfaction survey feedback in the context of a Hotel AAA. As shown, FIG. 4A shows a user interface screen 400A for starting a real-time survey, where a guest may enter their name, email address, and room number. By continuing, the guest may access screen 400B shown in FIG. 4B, where the guest may self-identify as being one of a corporate, recreational, family, government, or other type of hotel guest. Continuing to screen 400C on FIG. 4C, the guest may be prompted to rate their experience for a number of areas, such as “How was the appearance of the lobby?”, “How did you find our Hot Deluxe Continental Breakfast?”, “How was the front desk service?”, “How was the pool and waterslide?”, “How did you find the cleanliness of the hotel?”. The guest may also be provided space for providing extra comments.

Upon submitting the answers to the survey, or alternatively as answers to the questions are being submitted, real-time survey management server 130 may monitor the answers for any that are below and acceptable range (e.g. satisfactory), either individually, or based on some average of the answers. In the event that one or more answers may fall below an acceptable range and indicate poor or very poor, real-time survey management server 130 may immediately send a real-time survey result notification using a sub component within real-time survey management server 130, or via a real-time notification server 160 as shown in FIG. 1.

The real-time survey result notification may be immediately forwarded to a real-time survey result notification device, such as a mobile phone 170 belonging to a hotel manager 172, so that the hotel manager 172 can take immediate steps to address the issues raising concern for a hotel guest. As described earlier, the real-time survey result notification may include the particular questions to which a poor or very poor indication was received, so that the manager 172 already knows the general area(s) of concern for the hotel guest.

If, for whatever reason, a manager 172 is not able to immediately address an issue for a hotel guest either because the issue is complex, or requires further corrective steps to be taken, the manager 172 may follow up with the hotel guest via real-time survey management server 130 to at least acknowledge that the guest's concerns have been received, and that steps will be taken to correct the issue that has caused the guest to provide the low score. By immediately acknowledging the guest's real-time survey results, the guest may leave the hotel with the knowledge that their concerns have been heard, and that the hotel will take further steps to rectify their complaints.

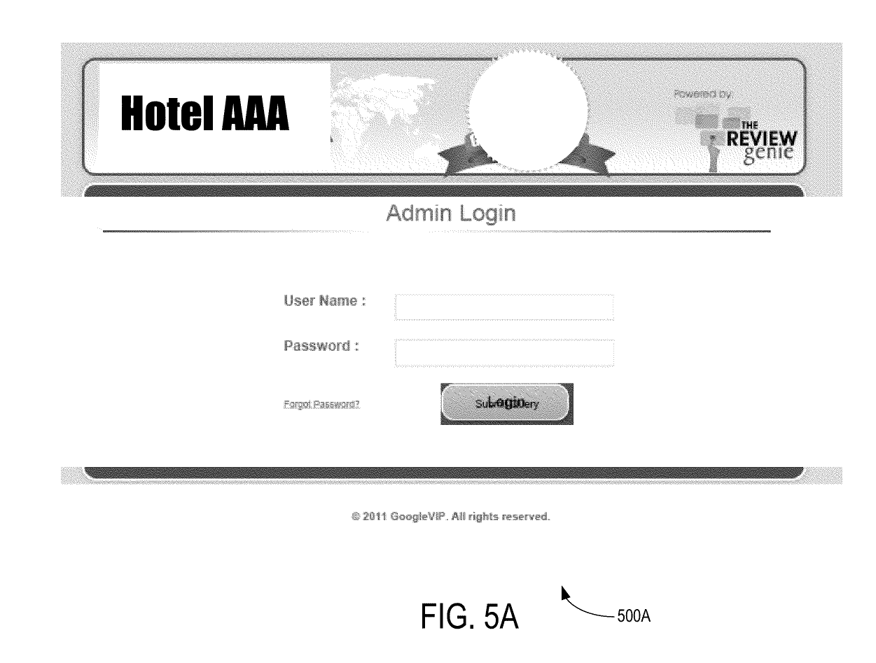

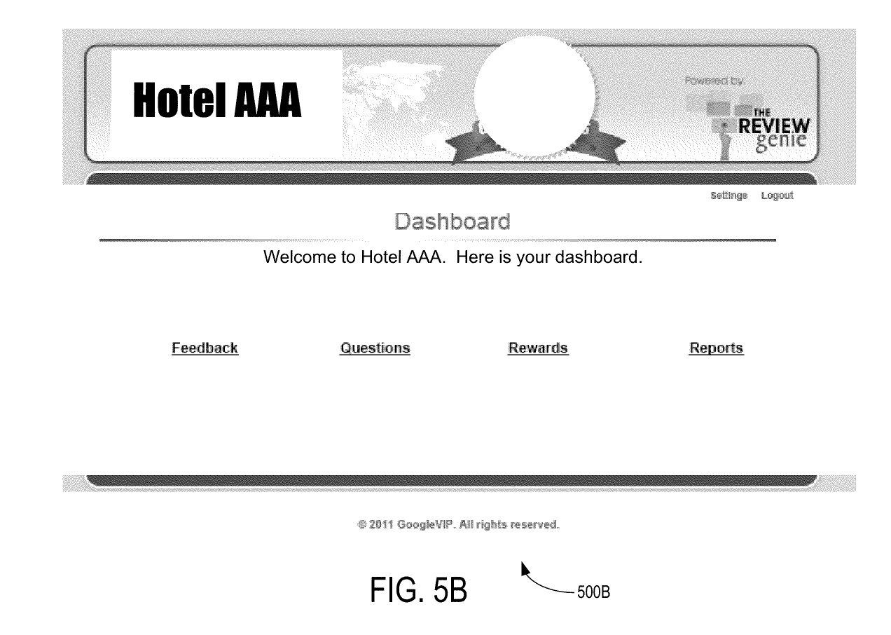

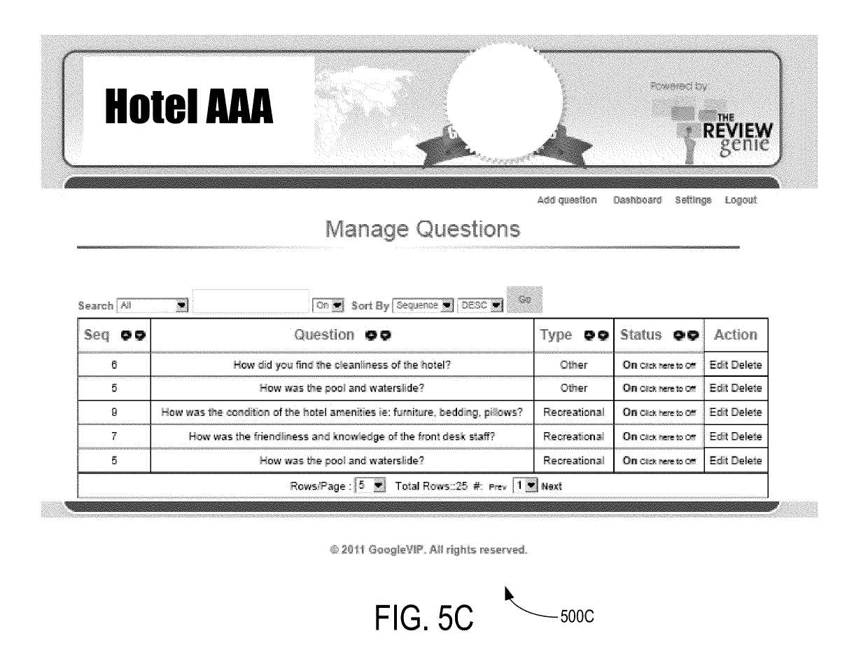

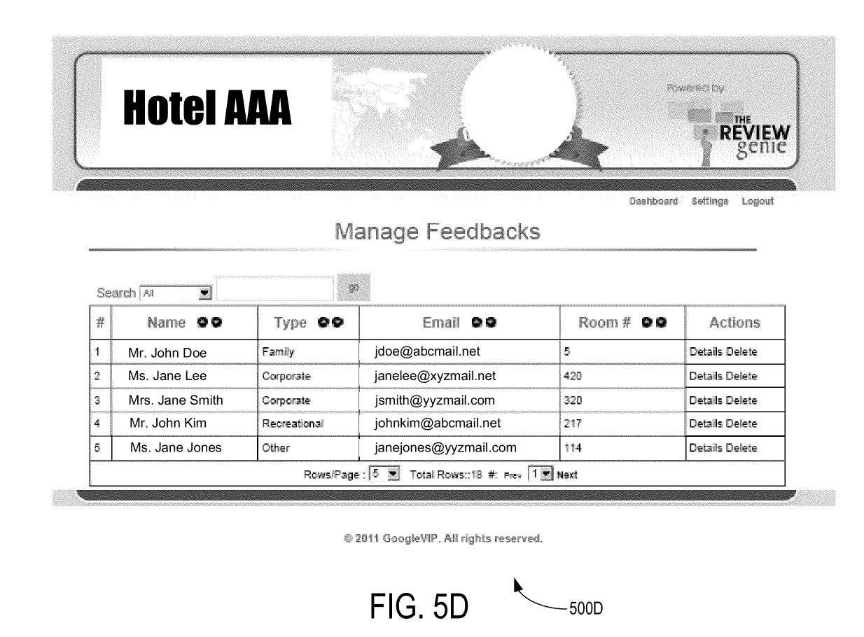

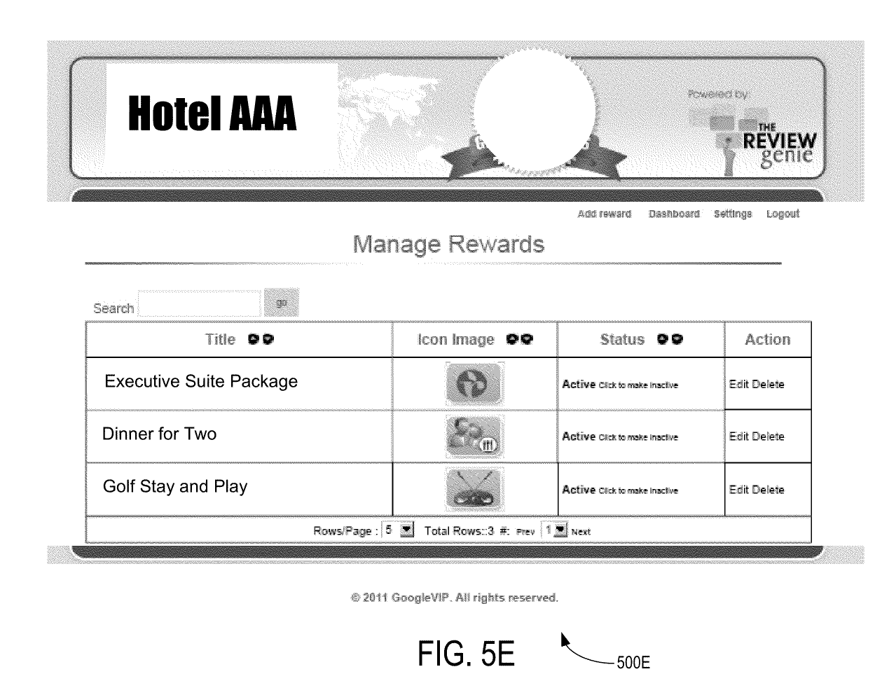

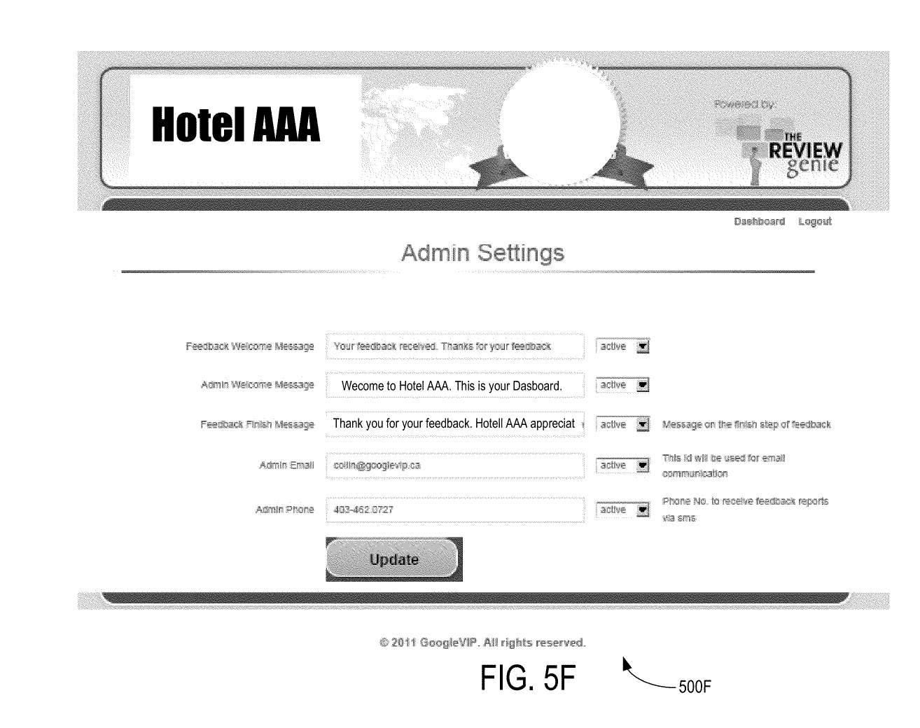

Now referring to FIGS. 5A-5F, shown are illustrative user interface screens for administering the real-time survey management system for the illustrative hotel use case as described above. For example, login screen 500A shown in FIG. 5A provides access to an administrator 182 by entering user name and password. Logging in brings the administrator 182 to dashboard screen 500B as shown in FIG. 5B, where the administrator 182 may access guest feedback, responses to questions, the types of rewards offered to address guest complaints, and various types of reports generated from the survey feedback.

Screen 500C as shown in FIG. 5C allows the administrator 182 to manage the survey questions by adding or deleting the questions asked. Screen 500D on FIG. 5D shows a feedback management screen, where feedback received from particular hotel guests have been recorded, including the guests' names, email addresses, self-identified guest type and room numbers. The administrator 182 can review the feedback from each guest, and confirm that the hotel manager 172 has either followed up with a guest with a complaint, or has at least acknowledged the survey feedback and has undertaken to follow up.

Now referring to FIG. 5E, shown are various types of rewards that may be won for completing the survey, or to be provided as compensation for guests who have had a poor experience due to the fault of the hotel. The administrator 182 may manage the types of rewards or compensation that may be provided.

Now referring to FIG. 5F, shown is a settings page where an administrator 182 can set various system administrative settings, including specifying an email address and telephone number for an administrator 182 or manager 172 to whom a message should be sent (e.g. by email, instant text messaging, or by telephone). Various other administrative preferences can also be set, including the messages appearing on the user interface screens as previously shown and described with reference to FIGS. 4A-4C.

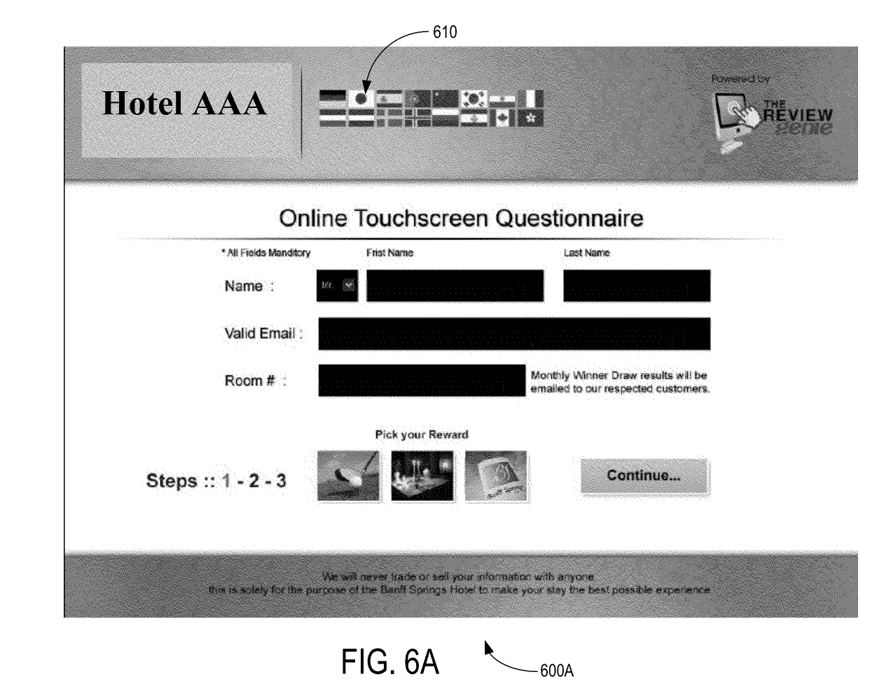

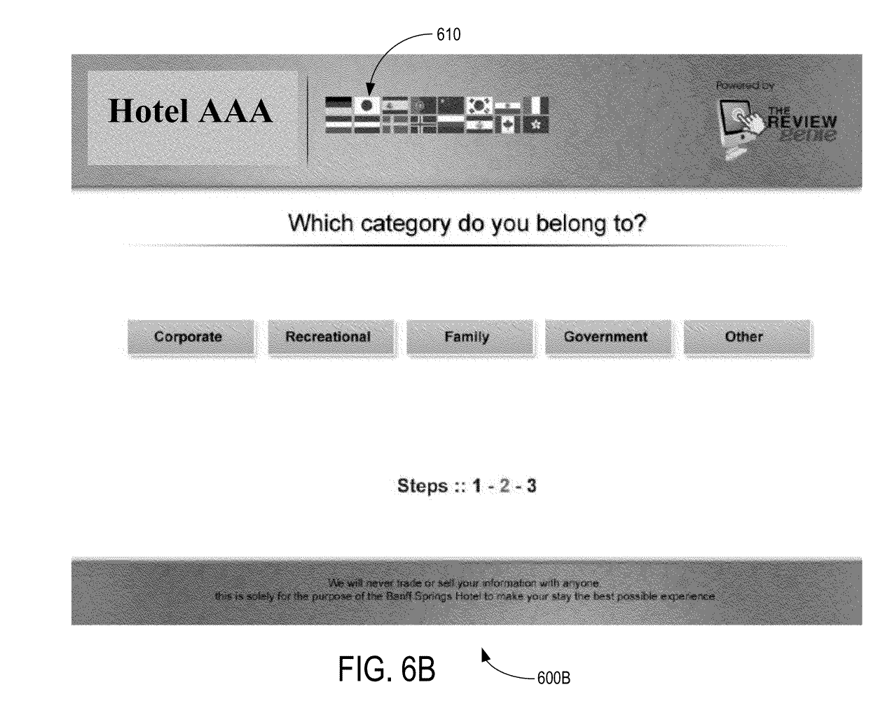

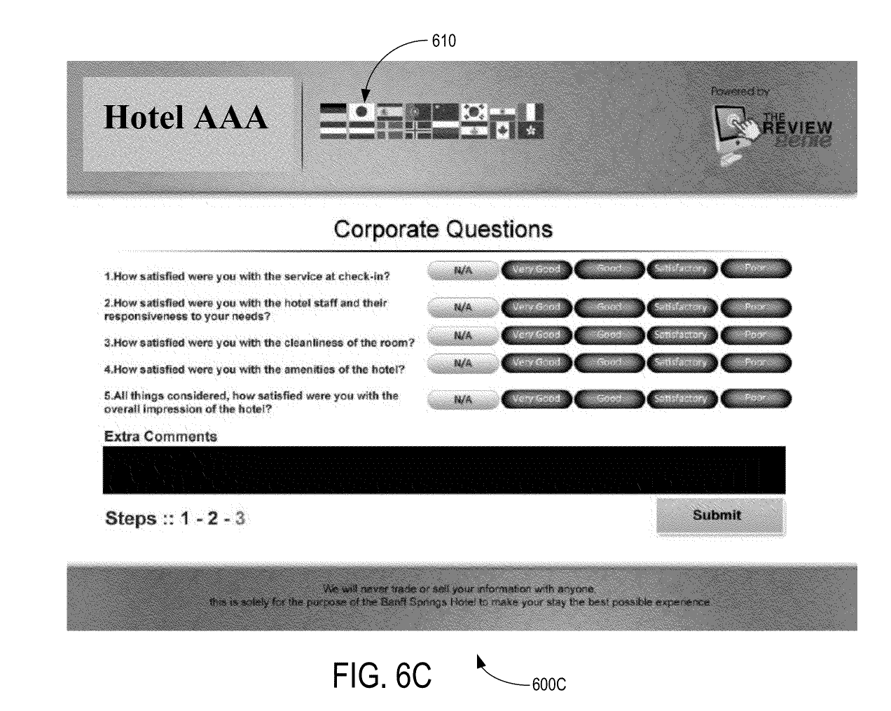

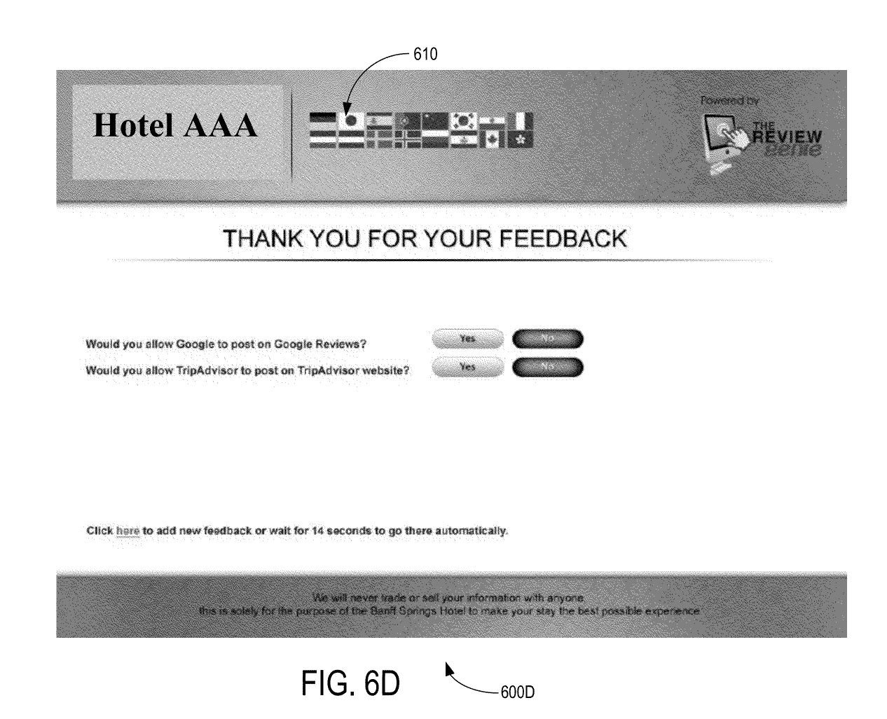

FIGS. 6A-6D show illustrative user interface screens for receiving real-time customer satisfaction survey feedback in various languages in accordance with another embodiment. As shown in screens 600A-600D, a user may select from one of many different languages in which to complete the satisfaction survey. The language selections available may be indicated, for example, by the national flags of countries in which the language is predominantly spoken. Thus, for example, clicking on the Japanese flag 610 will change the language of the survey to Japanese (although, English is shown in this example). In another embodiment, rather than using the national flags of countries as selectable buttons, the actual language may be used to identify the language selection button, for example: English, Francais (French), Deutsch (German), Español (Spanish), etc.

In an embodiment, real-time survey management server 130 may monitor the language in which the survey was taken by a guest, and the selected language may be communicated via a real-time notification server 160. The real-time survey result notification may be immediately forwarded to a real-time survey result notification device, such as a mobile phone 170 belonging to a hotel manager 172, so that the hotel manager 172. If the hotel has staff able to speak multiple languages, the real-time notification server 160 may be configured to forward the notification to the device of the appropriate person in dependence upon the selected language. At a minimum, the language selected by the guest may be used to send a response message to the guest in their selected language to indicate that further steps will be taken shortly to address their concerns. By customizing the satisfaction survey interface and response, and communicating in a language familiar to the guest, it is anticipated that the real-time or near real-time response will be more effective in locations such as hotels that may attract guests from around the world.

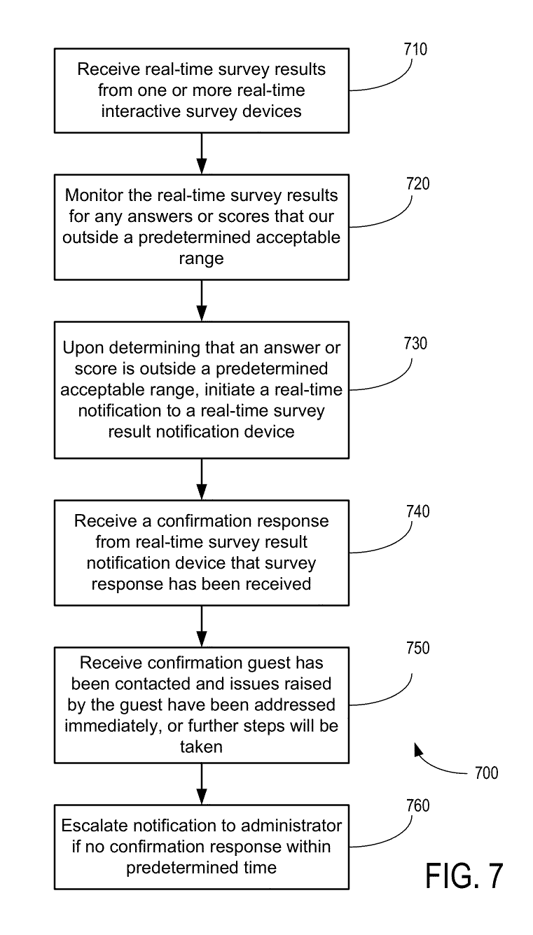

Now referring to FIG. 7, shown is a schematic flow chart of a method 700 in accordance with an embodiment. As shown, method 700 begins and at block 710 receives real-time survey results from one or more real-time interactive survey devices, such as real-time interactive survey devices 142, 144 and 146 described above.

Method 700 then proceeds to block 720, where method 700 monitors the real-time survey results for any answers or scores that our outside a predetermined acceptable range. For example, a minimum acceptable score as determined by a hotel may be a satisfactory score for all questions, or as another example, no more than one poor rating for all questions.

Method 700 then proceeds to block 730, where upon determining that an answer or score is outside a predetermined acceptable range, method 700 initiates a real-time notification to a real-time survey result notification device, such as real-time survey result notification device 170 as shown in FIG. 1. This allows a manager 172 to take immediate steps to address any issues raised by any one of guests 150A-150C.

Method 700 then proceeds to block 740, where in response to the real-time notification, the real-time survey management server 130 receives a confirmation response from real-time survey result notification device 170 that the guest survey response has been received.

Method 700 then proceeds to block 750, where method 700 further receives confirmation from device 170 that the manager 172 has contacted the guest to indicate that their survey response has been received, and that the manager has addressed the issues raised by the guest immediately, or will take further steps as may be necessary to address them.

Method 700 then proceeds to block 750 where, if confirmation of receipt is not received from the real-time survey result notification within a predetermined time, the notification is escalated to the administrator, or to a secondary manager contact, so that a timely response to the guest's survey results can be obtained. Method 700 then ends.

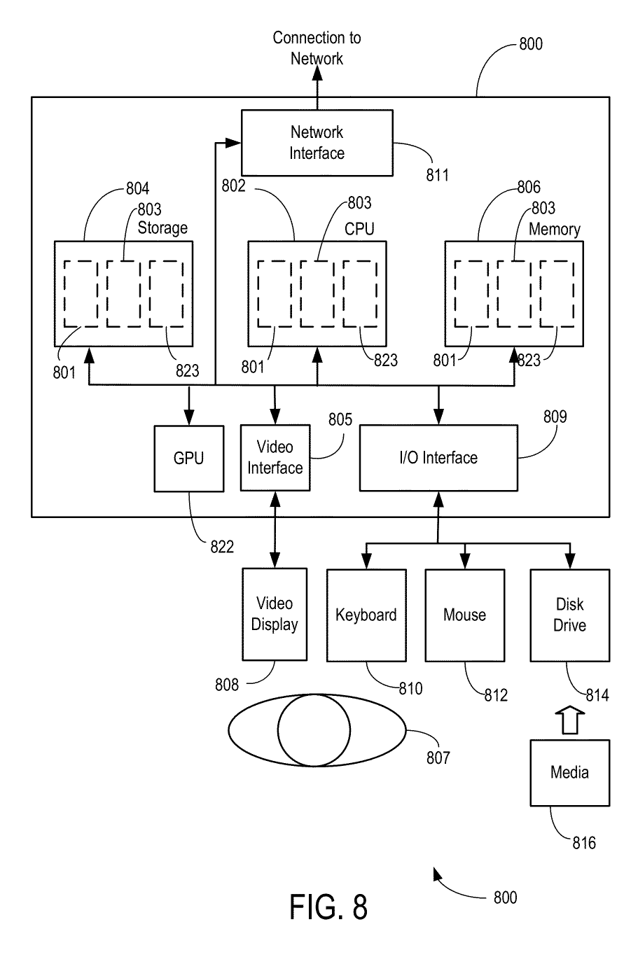

The present system and method may be practiced in various embodiments. A suitably configured computer device, and associated communications networks, devices, software and firmware may provide a platform for enabling one or more embodiments as described above. By way of example, FIG. 8 shows a generic computer device 800 that may include a central processing unit (“CPU”) 802 connected to a storage unit 804 and to a random access memory 806. The CPU 802 may process an operating system 801, application program 803, and data 823. The operating system 801, application program 803, and data 823 may be stored in storage unit 804 and loaded into memory 806, as may be required. Computer device 800 may further include a graphics processing unit (GPU) 822 which is operatively connected to CPU 802 and to memory 806 to offload intensive image processing calculations from CPU 802 and run these calculations in parallel with CPU 802. An operator 807 may interact with the computer device 800 using a video display 808 connected by a video interface 805, and various input/output devices such as a keyboard 810, mouse 812, and disk drive or solid state drive 814 connected by an I/O interface 809. In known manner, the mouse 812 may be configured to control movement of a cursor in the video display 808, and to operate various graphical user interface (GUI) controls appearing in the video display 808 with a mouse button. The disk drive or solid state drive 814 may be configured to accept computer readable media 816. The computer device 800 may form part of a network via a network interface 811, allowing the computer device 800 to communicate with other suitably configured data processing systems (not shown). One or more different types of sensors may be used to receive input from various sources.

The present system and method may be practiced on virtually any manner of computer device including a desktop computer, laptop computer, tablet computer or wireless handheld. The present system and method may also be implemented as a computer-readable/useable medium that includes computer program code to enable a computer device to implement each of the various process steps in a method in accordance with the present invention. It is understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portioned of a computing device, such as memory associated with a computer and/or a storage system.

Thus, in an aspect, there is provided a computer-implemented method for providing substantially real-time customer satisfaction survey feedback, comprising: providing an interactive electronic survey platform; receiving customer input for an interactive satisfaction survey; monitoring the customer input for any satisfaction levels below a minimum threshold; and in response to any satisfaction levels below the minimum threshold, communicating the customer input to a monitored device in substantially real-time.

In an embodiment, the method further comprises monitoring the customer input for any satisfaction levels below a minimum threshold at a real-time survey management server.

In another embodiment, the method further comprises providing a notification of the customer input for any satisfaction levels below a minimum threshold from the real-time survey management server to the monitored device to alert a human agent substantially real-time.

In another embodiment, the method further comprises generating an alert at the monitored device such that a human agent can be alerted to the customer input and take immediate steps to respond.

In another embodiment, the method further comprises generating an alert at the monitored device such that a human agent can be alerted to the customer input and take immediate steps to respond.

In another embodiment, the method further comprises providing the interactive electronic survey platform as a touch screen display at a kiosk.

In another embodiment, the method further comprises providing the interactive electronic survey platform as a touch screen display on a mobile tablet.

In another embodiment, the method further comprises providing the kiosk at a hotel lobby, and communicating the customer input for any satisfaction levels below a minimum threshold to a device monitored by an on-duty hotel manager.

In another embodiment, the method further comprises providing the mobile tablet at a restaurant table, and communicating the customer input for any satisfaction levels below a minimum threshold to a device monitored by an on-duty restaurant manager.

In another embodiment, the method further comprises providing a reward for completing the survey, and for customer input for any satisfaction levels below a minimum threshold.

In another aspect, there is provided a computer-implemented system for providing substantially real-time customer satisfaction survey feedback, wherein the system is adapted to: provide an interactive electronic survey platform; receive customer input for an interactive satisfaction survey; monitor the customer input for any satisfaction levels below a minimum threshold; and in response to any satisfaction levels below the minimum threshold, communicate the customer input to a monitored device in substantially real-time.

In an embodiment, the system is further adapted to monitor the customer input for any satisfaction levels below a minimum threshold at a real-time survey management server.

In another embodiment, the system is further adapted to provide a notification of the customer input for any satisfaction levels below a minimum threshold from the real-time survey management server to the monitored device to alert a human agent substantially real-time.

In another embodiment, the system is further adapted to generate an alert at the monitored device such that a human agent can be alerted to the customer input and take immediate steps to respond.

In another embodiment, the system is further adapted to generate an alert at the monitored device such that a human agent can be alerted to the customer input and take immediate steps to respond.

In another embodiment, the interactive electronic survey platform is a touch screen display at a kiosk.

In another embodiment, the interactive electronic survey platform is a touch screen display on a mobile tablet.

In another embodiment, the kiosk is provided at a hotel lobby, and the system is further adapted to communicate the customer input for any satisfaction levels below a minimum threshold to a device monitored by an on-duty hotel manager.

In another embodiment, the mobile tablet is provided at a restaurant table, and the system is further adapted to communicate the customer input for any satisfaction levels below a minimum threshold to a device monitored by an on-duty restaurant manager.

In another embodiment, the system is further adapted to provide a reward for completing the survey, and for customer input for any satisfaction levels below a minimum threshold.

It should be understood that further enhancements to the disclosed system, method and computer program are envisioned.

1. A computer-implemented method for providing substantially real-time customer satisfaction survey feedback, comprising:
providing an interactive electronic survey platform;
receiving customer input for an interactive satisfaction survey;
monitoring the customer input for any satisfaction levels below a minimum threshold; and
in response to any satisfaction levels below the minimum threshold, communicating the customer input to a monitored device in substantially real-time.

2. The computer-implemented method of claim 1, further comprising monitoring the customer input for any satisfaction levels below a minimum threshold at a real-time survey management server.

3. The computer-implemented method of claim 2, further comprising providing a notification of the customer input for any satisfaction levels below a minimum threshold from the real-time survey management server to the monitored device to alert a human agent substantially real-time.

4. The computer-implemented method of claim 1, further comprising generating an alert at the monitored device such that a human agent can be alerted to the customer input and take immediate steps to respond.

5. The computer-implemented method of claim 4, further comprising generating an alert at the monitored device such that a human agent can be alerted to the customer input and take immediate steps to respond.

6. The computer-implemented method of claim 1, further comprising providing the interactive electronic survey platform as a touch screen display at a kiosk.

7. The computer-implemented method of claim 1, further comprising providing the interactive electronic survey platform as a touch screen display on a mobile tablet.

8. The computer-implemented method of claim 6, further comprising providing the kiosk at a hotel lobby, and communicating the customer input for any satisfaction levels below a minimum threshold to a device monitored by an on-duty hotel manager.

9. The computer-implemented method of claim 7, further comprising providing the mobile tablet at a restaurant table, and communicating the customer input for any satisfaction levels below a minimum threshold to a device monitored by an on-duty restaurant manager.

10. The computer-implemented method of claim 1, further comprising providing a reward for completing the survey, and for customer input for any satisfaction levels below a minimum threshold.

11. A computer-implemented system for providing substantially real-time customer satisfaction survey feedback, wherein the system is adapted to:
provide an interactive electronic survey platform;
receive customer input for an interactive satisfaction survey;
monitor the customer input for any satisfaction levels below a minimum threshold; and
in response to any satisfaction levels below the minimum threshold, communicate the customer input to a monitored device in substantially real-time.

12. The computer-implemented system of claim 11, wherein the system is further adapted to monitor the customer input for any satisfaction levels below a minimum threshold at a real-time survey management server.

13. The computer-implemented system of claim 12, wherein the system us further adapted to provide a notification of the customer input for any satisfaction levels below a minimum threshold from the real-time survey management server to the monitored device to alert a human agent substantially real-time.

14. The computer-implemented system of claim 11, wherein the system is further adapted to generate an alert at the monitored device such that a human agent can be alerted to the customer input and take immediate steps to respond.

15. The computer-implemented system of claim 14, wherein the system is further adapted to generate an alert at the monitored device such that a human agent can be alerted to the customer input and take immediate steps to respond.

16. The computer-implemented system of claim 11, wherein the interactive electronic survey platform is a touch screen display at a kiosk.

17. The computer-implemented system of claim 11, wherein the interactive electronic survey platform is a touch screen display on a mobile tablet.

18. The computer-implemented system of claim 16, wherein the kiosk is provided at a hotel lobby, and the system is further adapted to communicate the customer input for any satisfaction levels below a minimum threshold to a device monitored by an on-duty hotel manager.

19. The computer-implemented system of claim 17, wherein the mobile tablet is provided at a restaurant table, and the system is further adapted to communicate the customer input for any satisfaction levels below a minimum threshold to a device monitored by an on-duty restaurant manager.

20. The computer-implemented system of claim 11, wherein the system is further adapted to provide a reward for completing the survey, and for customer input for any satisfaction levels below a minimum threshold.
